(19) United States
(12) Patent Application Publication
(10) Pub. No.: US 2012/0298733 A1
(43) Pub. Date: Nov. 29, 2012

(54) Hermetically Sealed Paperboard Container

(76) Inventors: Qihua Xu, Cary, NC (US); Todd Huffman, Richmond, VA (US); Timothy McLaughlin, Mechanicsville, VA (US); Zhiquan Q. Yan, Richmond, VA (US)

(21) Appl. No.: 13/567,385

(22) Filed: Aug. 6, 2012

Related U.S. Application Data
(63) Continuation-in-part of application No. PCT/US2010/057005, filed on Nov. 17, 2010.
Application No. PCT/US2010/057005 is a continuation-in-part of application No. PCT/US2010/035704, filed on May 21, 2010.

(51) Int. Cl. B65D 3/22; B31B 1/64; B31B 1/20

(52) U.S. Cl. 229/124; 493/56

(57) ABSTRACT

A hermetically-sealed paperboard container is disclosed that may be produced using a conventional converting machine but at a converting temperature of at least 93° C. lower than a conventional converting temperature. The formation of pin holes or rupture on the barrier structure during the converting process can be significantly reduced, resulting in the hermetically-sealed paperboard container with enhanced barrier performances.

### PRIORITY

This application is a continuation-in-part of PCT/US2010/057005 filed on Nov. 17, 2010, which claims priority from PCT/US2010/035704 filed on May 21, 2010. The entire contents of both PCT/US2010/057005 and PCT/US2010/035704 are incorporated herein by reference.

### FIELD

This application relates to paperboard containers and, more particularly, to hermetically sealed paperboard containers.

### BACKGROUND

Paper-based containers with barrier properties are typically formed from paper-based blank comprising paperboard substrate and functionalized layers such as oxygen and moisture barrier layers. The blank is die cut to the desired silhouette and then formed into a shape by wrapping it once around a mandrel. The overlapping ends of the blank form a straight seam having an underlying portion and an overlying portion. FIG. 1 shows a cross sectional view of the container body 100 made by overlapping ends of the blank 101 into a straight seam having an underlying portion 102 and an overlying portion 103. The raw edge 104 of the underlying portion of the seam is exposed to the container content, resulting in a reduction of the barrier performance of the container. Several techniques have been reported to prevent the raw edge 104 of the seam from being exposing to the packaged content.

One approach is to cover the exposed raw edge of the blank with a strip of barrier tape. Examples of the known materials as a barrier tape to protect the raw edges of the paperboard containers include metal foils such as aluminum foil and tin foil, low density polyethylene (LDPE), ethylene-vinyl alcohol copolymer (EVOH), polyethylene terephthalate (PET), glycol modified PET, nylon, and combinations thereof. U.S. Pat. No. 5,620,135 discloses a technique for covering the raw edge of the body with a protective covering tape. PCT Application No. WO 2003/106277 discloses a single wrap container having the exposed underlying edge of the paper-based container body enclosed by a tape that comprises a layer of metalized PET interposed between layers of LDPE. Using protective tapes to cover the raw edges, however, has several drawbacks. The adhered protective tape is an additional cost, and may be easily removed. Furthermore, an additional process is required to apply the protective tapes, resulting in further increase in cost and complexity of the manufacturing process.

Another approach commonly used in multiply tubular container process is to fold the underlying edge portion of the barrier liner ply into an “anaconda” fold, wherein the underlying edge is folded back on itself and adhere to the overlying edge. An example of such a fold is illustrated in U.S. Pat. No. 5,084,284. The main drawback of anaconda fold is the undesired increase in thickness of the seam, as it is three times the thickness of the blank. Cracks tend to form with such high thickness, resulting in a leakage of the contents, an influx of the outside air, and a reduction in barrier performance of the containers. Furthermore, such undesirably high thickness of the seam poses difficulties when attempting to hermetically seal the ends of the container body itself, as well as seal the top lid and bottom to the container body. To address the difficulty in folding the paper-based blank during the formation of the container body, several techniques have been used to reduce the thickness of the blank.

U.S. Pat. No. 6,190,485 discloses the production of a hermetically sealed spiral-wound multi-ply container without using “anaconda” fold. However, this process is based on the use of continuous webs of paperboard ply and liner ply, which requires rather intensive handlings, relatively high shipping and storage costs.

Another approach of protecting the raw edge of the blank is “skiving and hemming”, as described in U.S. Pat. No. 5,236,408. Skiving is removing half the thickness of the paperboard from the side seam flap. Hemming is folding the skived area back onto itself and sealing the other edge over the hemmed area by heat or flame. This approach has been used for producing gable top cartons for the liquid packaging industry, as described in U.S. Pat. No. 5,810,243. While the raw edge of the vertical side seam of the carton is protected, special sealing techniques using sealing jaws are required, such as those described in the International Patent Application No. WO 2008/025996 and WO 1990/009926, to seal the folded top and bottom flaps to achieve hermetically sealed carton.

Achieving hermetically sealed barrier paperboard cup using the “skiving and hemming” approach is difficult on the paperboard cup forming machine, which is typically designed to produce liquid-tight container with a top rim not designed for gas tight seal. The increased thickness of the skived/hemmed edge area over the original paperboard provided additional challenge in producing hermetically sealed bottom in the area where the thick skived/hemmed seam meets the bottom in the overlapped area. The skived edge also substantially increases the abrupt step at the seam of the top rim formed by the overlapped ends of the blank, and the non-planar hill-like surface of the rim makes hermetic seal of the lidding membrane (film or paper) more difficult.

GB Patent Application No. 2055743 discloses a paper-based container comprising a hollow container body having recessed structure on the upper and lower ends, a top lip positioning on the recessed top of the container body, and a bottom positioning on the recessed bottom. The hollow container body is produced by skiving one longitudinal end of a paper-based blank to substantially half its thickness for a predetermined width and then forming a longitudinal groove substantially at the center of the skived portion. A heat-resistant adhesive is applied to the skived portion and irradiated with infrared rays to evaporate water contained therein. The skived portion is then folded about the groove so that the end face of the skived paper and the end face of the unskived portion contact each other. This process of producing barrier container is, however, rather complicated and high cost due to the use of adhesives and the recessed structure of the upper and lower ends.

Up until the present disclosure, to the inventor's knowledge, hermetically sealed barrier paperboard cup has not been achieved commercially using the “skiving/hemming/flame sealing” approach without adhesives on regular cup forming machines.

Accordingly, there is still a need for hermetically sealed paperboard containers with enhanced barrier and seal performances that may be produced by a process that is more effective and economical using commercially available high-speed liquid packaging skiving/hemming/sealing equipment and cup forming machines without the use of adhesives. One advantage of such approach is the potential for the in-plant system, where skived blanks can be shipped flat to the packaging plant where the barrier cups are formed using in-plant cup forming machines.

It is further beneficial to have hermetically sealed paperboard containers with excellent barrier performance that do not require the use of metal foils to impart the barrier properties.

### SUMMARY

In one aspect, disclosed is a hermetically sealed paperboard container that may be produced using a conventional converting machine but at a converting temperature of at least 93° C. lower than a conventional converting temperature. The formation of pin holes or rupture on the barrier structure during the converting process can be significantly reduced, resulting in the hermetically-sealed paperboard container with enhanced barrier performances

Other aspects of the disclosed hermetically sealed paperboard container will become apparent from the following detailed description, the accompanying drawings and the appended claims.

### BRIEF DESCRIPTION OF THE DRAWINGS

FIG. 1 shows a cross sectional view of the paperboard container body of prior arts, wherein the overlapping ends of the blank form a seam with a raw edge exposed to the packaged content;

FIG. 2 shows an example of the typical multilayer barrier structure for the formation of paperboard containers with barrier performance;

FIG. 3 shows one embodiment of the disclosed multilayer barrier structure;

FIG. 4 shows a schematic illustration of the formation of container body, wherein the folded longitudinal end of the blank is overlapped inside the other longitudinal end of the blank to form a side seam; and

FIG. 5 shows one embodiment of the disclosed hermetically-sealed paperboard container, comprising a container body component with a rolled rim on the upper end and a recessed configuration at the lower end, a top lid, and a bottom component.

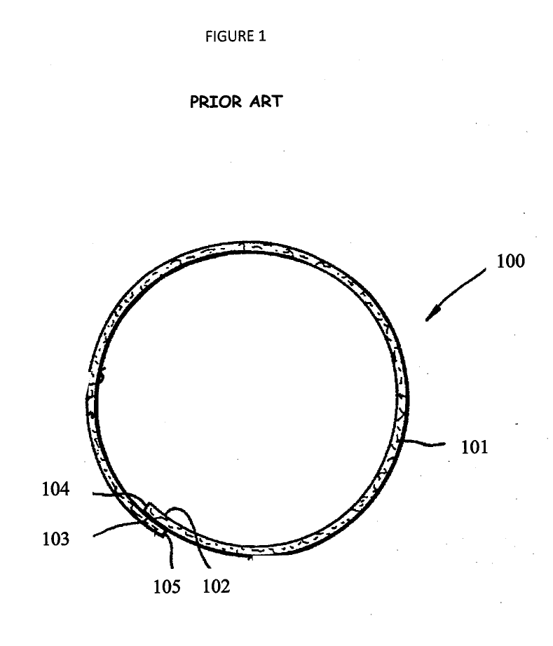

### DETAILED DESCRIPTION

The present disclosure now will be described more fully hereinafter, but not all embodiments of the disclosure are necessarily shown. While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof.

### The Multilayer Barrier Materials

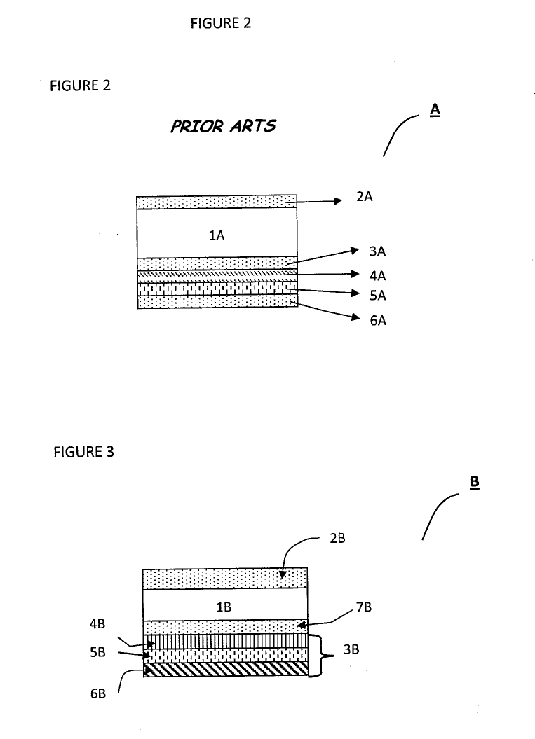

FIG. 2 shows an example of the typical multilayer material A for the production of containers having barrier performance. The paperboard substrate 1A is coated one side with a heat sealant layer 2A and the other side with a barrier structure, which comprises low density polyethylene (LDPE) polymer 3A, barrier polymer 4A, and tie layer 5A. Then, a layer of heat sealant layer 6A is applied onto the surface of tie layer 5A. When desired, the barrier structure may be applied onto the paperboard substrate 1A by co-extrusion of LDPE polymer 3A, EVOH polymer 4A, and tie layer A5.

However, the hermetically-sealed container formed from the multilayer structure of FIG. 2 typically shows insufficient barrier performance, such as oxygen barrier, for various end use packaging applications. This is due to the pin holes or ruptures in the barrier structure formed during the converting process of the multilayer structure into the container. As a result, the formed container exhibits such high oxygen transmission rate that it would not meet shelf life target of 12 to 18 months commonly required for hermetical packaging applications. The formation of pinholes or rupture may be due to the excessive temperatures used during the cup forming (i.e., converting) process, as well as the film breakage due to bottom seal separation by paperboard memory force.

The multilayer materials of the present disclosure allow for the converting process into hermetically-sealed container at much lower temperature ranges compared to the standard converting temperatures, thus reducing the formation of pin holes or ruptures in the barrier structure during the converting process. In one embodiment, the disclosed multilayer barrier structure may be converted into a hermetically-sealed container at 200° F. (93° C.) lower than the standard converting temperatures. The formations of pin holes and ruptures during the converting process may be reduced, resulting in the hermetically-sealed container with improved barrier performance. Additionally, the disclosed multilayer barrier materials may provide an improved hot tack strength and overall bond strength.

The disclosed multilayer barrier materials may be designed to optimize the barrier performance of the formed hermetically-sealed containers for various packaging end use applications. The barrier structure may be designed for improved gas barrier performance, such as oxygen barrier, with some other barrier properties such as water vapor barrier performance.

The disclosed barrier multilayer material comprises:
(a) a substrate having a first side and a second side;
(b) a sealant layer positioned on the first side of the substrate; and
(c) a barrier-containing structure positioned on the second side of the substrate, wherein the barrier-containing structure includes at least:
   (i) a layer of barrier material, and
   (ii) a layer comprising a specialized low melting point polyethylene-based polymer positioned over the layer of barrier material, the specialized polyethylene-based polymer having a density range of 0.75 g/cm³ to 1.00 g/cm³ and a melting point range of 80° C. to 120° C.

The suitable specialized low melting point polyethylene-based polymers having the density and melting point properties in the aforementioned ranges may include, but are not limited to, very low density polyethylene (VLDPE), ionic polyethylene copolymer, and combinations thereof.

VLDPE is recognized by ones skilled in the arts as a substantially linear PE polymer with high levels of short-chain branches that is commonly made by copolymerization of ethylene with short-chain-olefins. VLDPE polymer is generally characterized by a density range of 0.880-0.915 g/cm³.

In one embodiment, the specialized low melting point polyethylene-based polymer may be a very low density polyethylene having a density range of 0.880 g/cm³ to 0.915 g/cm³ and a melting point range of 80° C. to 120° C.

In one embodiment, the specialized low melting point polyethylene-based polymer may be ionic polyethylene copolymers. Examples of such copolymers include, but are not limited to, SURLYN® ethylene/methacrylic acid polymers commercially available from Dupont, such as SURLYN®1652 with a density of 0.94 g/cm³ and a melting point of 100° C.

Ones skilled in the art appreciate that VLDPE and SURLYN® ethylene/methacrylic acid polymers are disclosed as mere examples, and other polyethylene-based polymers having the specified density and melting point ranges may be readily used in the present disclosure.

In one embodiment, the barrier-containing structure is performed and then positioned onto the surface of substrate, which may be achieved various known application methods. These application methods may include, but are not limited to, adhesive lamination.

In one embodiment, each layer component of the barrier-containing structure is co-extruded onto the surface of substrate.

In one embodiment, each layer component of the barrier-containing structure is applied consecutively onto the surface of substrate.

It is to be understood that the barrier-containing structure may be placed onto the surface of substrate by any other appropriate application techniques, and the aforementioned three embodiments are merely examples.

FIG. 3 illustrates one embodiment of the disclosed multilayer barrier material. The multilayer material B comprises a substrate 1B; a first heat sealant layer 2B positioned on one side of the substrate; a barrier-containing structure positioned on the other side of the substrate, and optionally, a tie layer 7B positioned between the substrate 1B and the barrier-containing structure 3B. Optionally, the barrier-containing structure may further include at least one of layer of PE-polymer, tie layer, and adhesive tie layer.

### (I) The Barrier-Containing Structure

One embodiment of the barrier-containing structure suitable for use in the present disclosure is illustrated in FIG. 3. The barrier-containing structure 3B includes a layer of PE-based polymer 4B, a layer of barrier material 5B, and a layer of specialized low melting point polyethylene-based polymer 6B.

In one embodiment, the total thickness of the barrier-containing structure 3B is in a range of about 2.0 mils to 4.0 mils. In one embodiment, its thickness is about 3.0 mils.

The Layer of Barrier Material

A variety of barrier materials may be used in the present disclosure, and its selection depends on the desired level of barrier performance. Exampled of suitable barrier materials include, but are not limited to, ethylene-vinyl alcohol copolymer (EVOH), polyvinyl alcohol (PVA or PVOH), nylons, polyethylene terephthalate (PET), polyamide, polyvinylidene chloride, cyclic olefin copolymer, metalized polymer film, aluminum foil, materials derived from water-based barrier coatings, materials derived from aluminum oxide (Al₂O₃), silicon oxide (SiOₓ) barrier coatings, and combinations thereof. A variety of water-based barrier coatings known for imparting the barrier properties to paperboard may be used in the present disclosure to provide a barrier layer. When desired, the water-based barrier coatings may include nanoparticles to provide the tortuous effect that hinders the diffused molecules through the coating. Additionally, the thickness of the barrier polymer layer may be optimized to provide barrier performance suitable for the selected end use applications.

In one embodiment, the EVOH may be used as a barrier material for 5B and its layer thickness is tailored to meet the desired oxygen barrier performance of less than 10 cc/100 in²/atm/day at a temperature of 23° C. and at 0% relative humidity. In one embodiment, the EVOH layer thickness is in a range of 0.25 mils to 0.75 mils. In one embodiment, the EVOH layer thickness is in a range of 0.25 mils to 0.50 mils. In one embodiment, the EVOH layer thickness is in a range of 0.25 mils to 0.40 mils.

The Layer Comprising Specialized Low Melting Point Polyethylene-Based Polymer

In one embodiment, the specialized low melting point polyethylene-based polymer included in layer 6B in FIG. 3 of the barrier-containing structure 3B has a melting point range of about 80° C. to 120° C. In one embodiment, the specialized low melting point polyethylene-based polymer has a melting point range of about 100° C. to 110° C.

The suitable low melting point polyethylene-based polymers having the density and melting point properties in the aforementioned ranges may include, but are not limited to, very low density polyethylene (VLDPE), ionic polyethylene copolymer, and combinations thereof.

The thickness of this 6B layer may be a range of about 0.75 mils to 2.0 mils, which is about 19 mm to 50 mm. In one embodiment, the thickness of this layer may be in a range of about 1.0 mil to 1.6 mils.

Optional Layer of PE-Based Polymer

When desired, the barrier-containing structure may further include a layer of PE-based polymer (shown as 4B in the FIG. 3).

In one embodiment, the PE-based polymer 4B is a linear low density polyethylene (LLDPE) and its layer thickness is tailored to meet the desired performance of the final multilayer barrier structure. In one embodiment, its thickness is in a range of 1.00 mils to 1.60 mils. In one embodiment, its thickness is in a range of 1.20 mils to 1.30 mils.

### (II) The Sealant Layer

Suitable sealant polymers for the 2B layers of the present disclosure may include, but are not limited to, polyester; low density polyethylene (LDPE); high density polyethylene (HDPE); ethylene-vinyl acetate copolymer (EVA); ethylene methyl acrylate (EMA) copolymer; ionomer polymers such as poly(ethylene-co-methacrylic acid) (EMAA) copolymer SURLYN® commercially available from DuPont; and combinations thereof.

### (III) The Substrate

For the body component of the disclosed hermetically-sealed container, a variety of paperboard may be used as the substrate. These include, but are not limited to, coated natural kraft board (CNK board), solid bleached sulfate board (SBS), solid unbleached sulfate board (SUS), coated recycled board (CRB), coated white lined chipboard (WLC), folding boxboard (FBB), and other paperboard grades suitable for cup formation.

For the lid component or the bottom component, various substrates known for packaging applications may be used as the substrate. Examples of these substrates include, but are not limited to, paper-based material such as paperboard; plastics; foil-based materials such as aluminum foil; metallized film; and combinations thereof.

### (IV) The Tie Layer (Optional)

Optionally, the disclosed multiple barrier material B may include a tie layer 7B positioned between the substrate 1B and the barrier-containing structure 3B. Any known tie layer materials may be used in the present disclosure. When desired, this optional lie layer may be adhesive tie layer. In one embodiment, the PE-based polymer is used as an optional tie layer. Examples of such PE-based polymers suitable for the 7B layers may include, but are not limited to, low density polyethylene (LDPE); high density polyethylene (HDPE); and combinations thereof. In one embodiment, the 7B layer is made of LDPE polymer.

### Formation of the Body Component

The disclosed multilayer barrier material is die cut to a desired silhouette to provide a blank including a first and a second longitudinal ends. The first longitudinal end of the blank is skived to a predetermined thickness for a predetermined width. The resulting skived end of the blank is treated with heat, then folded and sealed over the blank to provide the folded first longitudinal end.

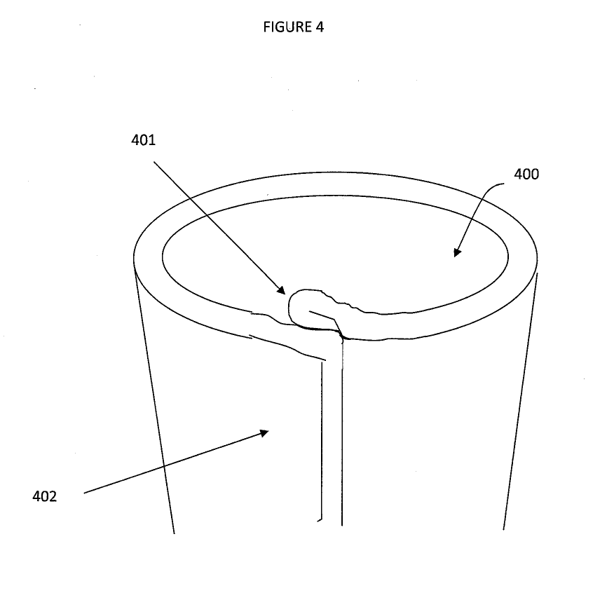

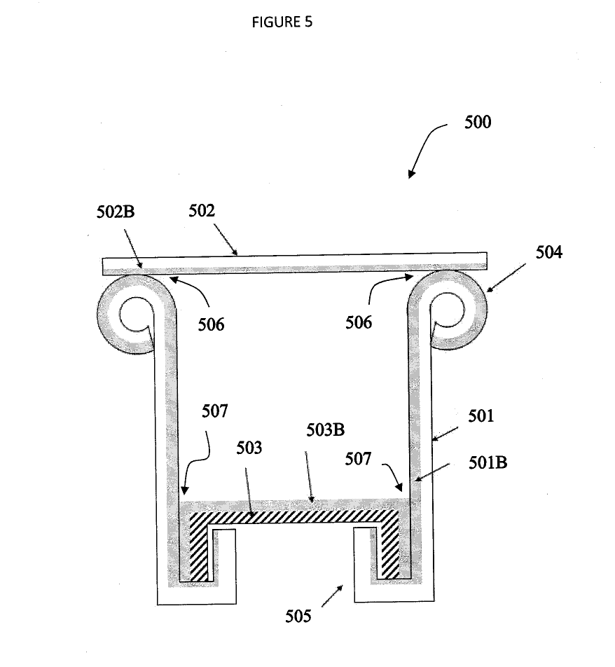

As shown in FIG. 4, the container body component 400 is formed by overlapping both longitudinal ends of the blank such that the folded first longitudinal end 401 is inside the second longitudinal end 402, and subsequently the overlapped seam is sealed.

### The Lid Component

The lid component may be derived from any material having appropriate barrier properties for the selected end use applications of the hermetically-seal containers.

In one embodiment, the lid component comprises plastic; foil-based materials such as aluminum foil; metallized film; and combinations thereof.

In one embodiment, the lid component comprises a substrate and a layer of barrier material positioned on at least one surface of the substrate.

In one embodiment, the lid component comprises:

(a) a substrate; and

(b) a barrier-containing structure positioned on at least one surface of the substrate, the barrier-containing structure including:
(i) a layer of barrier material, and
(ii) a layer comprising a specialized low melting point polyethylene-based polymer positioned over the layer of barrier material, the specialized polyethylene-based polymer having a density range of 0.75 g/cm³ to 1.00 g/cm³ and a melting point range of 80° C. to 120° C.

The suitable specialized low melting point polyethylene-based polymers having the density and melting point properties in the aforementioned ranges may include, but are not limited to, very low density polyethylene (VLDPE), ionic polyethylene copolymer, and combinations thereof.

Suitable substrates for the lid component may include, but not limited to, paper-based material such as paperboard; plastics; foil-based materials such as aluminum foil; metallized film; and combinations thereof.

In one embodiment of the present disclosure, the lid component comprises a paperboard, a layer of barrier material or of barrier-containing structure on at least one surface of the paperboard, and a sealant layer positioned over the layer of barrier material or of barrier-containing structure.

When desired, the lid component may be made of the same or similar material as that for the body component.

Several methods may be used for hermetically sealing the lid component to the body component. Example of such hermetic seals include, but are not limited to, hermetically seal the top with a plastic rim; a sealant bead dropped at the step-down area; a sealant bead added to the entire top rim before lidding; a lidding material with a heavy sealant such as those lidding film used for sealing barrier trays; a higher sealing pressure to press down lidding material to flatten the rim for maximum seal; and combinations thereof.

### The Bottom Component

The bottom component may be derived from any material having appropriate barrier properties for the selected end use applications of the hermetically-seal containers.

In one embodiment, the bottom component comprises plastic; foil-based materials such as aluminum foil; metallized film; and combinations thereof.

In one embodiment, the bottom component comprises a substrate and a layer of barrier material positioned on at least one surface of the substrate.

In one embodiment, the bottom component comprises:

(a) a substrate; and

(b) a barrier-containing structure positioned on at least one surface of the substrate, the barrier-containing structure including:

(i) a layer of barrier material, and

(ii) a layer comprising a specialized low melting point polyethylene-based polymer positioned over the layer of barrier material, the specialized polyethylene-based polymer having a density range of 0.75 g/cm³ to 1.00 g/cm³ and a melting point range of 80° C. to 120° C.

The suitable specialized low melting point polyethylene-based polymers having the density and melting point properties in the aforementioned ranges may include, but are not limited to, very low density polyethylene (VLDPE), ionic polyethylene copolymer, and combinations thereof.

Suitable substrates for the bottom component may include, but not limited to, paper-based material such as paperboard; plastics; foil-based materials such as aluminum foil; metallized film; and combinations thereof.

In one embodiment of the present disclosure, the bottom component comprises a paperboard, a layer of barrier material or of barrier-containing structure on at least one surface of the paperboard, and a sealant layer positioned over the layer of barrier material or of barrier-containing structure.

When desired, the bottom component may be made of the same or similar material as that for the body component.

The bottom component may be formed by die-cutting a roll stock, then assembled to the lower end of the body component and hermetically sealed.

In one embodiment, the body component may be joined with the bottom component by wrapping the body component around the bottom component. When desired, the roll stock used for the bottom component may be the same multilayer structure as that for the body component.

The bottom may be assembled to the body component by various sealing technologies. Examples of such sealing may include, but not limited to, hot air heat seal and ultrasound sealing. The sealing process may be optimized based on various factors. Some of these factors include, but are not limited to, the thickness of the sealant layer on the bottom; and the processing conditions such as lower sealing temperature to prevent the formation of pinhole, and higher sealing pressure to minimize the formation of gap between the bottom and the body component.

### Formation of the Hermetically-Sealed Containers

After formation of the body component, the configuration of the upper and lower ends of the body may be constructed to support the sealing with the lid and the bottom components. Any known configurations for the upper and lower ends of the container body may be used in the present disclosure, and the selection of such configuration depends on the desired packaging applications of the container. Examples of the configurations for the upper and lower ends of the container body may include, but are not limited to, recessed structure, rolled bead, flange, and combinations thereof.

The disclosed multilayer barrier materials may be converted to hermetically-sealed containers with improved barrier performance using the standard cup converting machine and by a careful selection and control of converting process conditions, such as sealing time, temperature and pressure.

A typical cup forming machine consists of a blank feeding system, heating elements, carousal forming station, bottom stock web feeding and die cutting, rim curl station, transport system, and a packaging/inspection station. The heating elements provide a controlled heating process to activate the sealant layer. The heating elements are applied for a side seam of the container body component, as well as for the sealing between the container body component and bottom component of the cup. The typical heating method is by blowing hot air through multiple nozzles to the selected areas of the structure. Nonetheless, other heating methods may be used to activate the sealant such as infrared heating. The temperature of the hot air needed to activate the sealant is highly dependent on the sealant composition and speed of the machine (i.e., sealing time).

The disclosed hermetically-sealed paperboard container with enhanced barrier performance comprises:

(A) a body component including an upper end, a lower end, and a skive-and-hem side seal, wherein the body component is formed from a multilayer barrier material comprising:
(a) paperboard having a first side and a second side,
(b) a sealant layer on the first side of the substrate; and
(c) a barrier-containing structure positioned on the second side of the paperboard, wherein the barrier-containing structure includes:
   (i) a layer of barrier material, and
   (ii) a layer comprising a specialized low melting point polyethylene-based polymer positioned over the layer of barrier material, the specialized polyethylene-based polymer having a density range of 0.75 g/cm³ to 1.00 g/cm³ and a melting point range of 80° C. to 120° C.;

(B) a bottom component sealed to the lower end of the body component; and

(C) a lid component hermetically sealed to the upper end of the body component.

In one embodiment, at least one of the bottom component and the lip component is made of the same multilayer barrier material as that of the body component.

In one embodiment, at least one of the bottom component and the lip component is made of a material including paper-based material such as paperboard; plastics; foil-based materials such as aluminum foil; metallized film; and combinations thereof.

In one embodiment, at least one of the bottom component and the lip component is made of a multilayer barrier material comprising:

(a) a substrate having a first side and a second side,

(b) a sealant layer on the first side of the substrate; and

(c) a barrier-containing structure positioned on the second side of the substrate, wherein the barrier-containing structure includes:
(i) a layer of barrier material, and
(ii) layer comprising a specialized low melting point polyethylene-based polymer positioned over the layer of barrier material, the specialized polyethylene-based polymer having a density range of 0.75 g/cm³ to 1.00 g/cm³ and a melting point range of 80° C. to 120° C.

Examples of substrates include, but not limited to, paper-based material such as paperboard; plastics; foil-based materials such as aluminum foil; metallized film; and combinations thereof.

The method of producing a hermetically-sealed paperboard container of the present disclosure comprises steps of:
(1) producing a multilayer barrier material characterized by:
   (a) paperboard having a first side and a second side,
   (b) a first sealant layer on the first side of the paperboard,
   (c) a barrier-containing structure positioned on the second side of the paperboard, wherein the barrier-containing structure includes:
      (i) a layer of barrier material, and
      (ii) layer comprising a specialized low melting point polyethylene-based polymer positioned over the layer of barrier material, the specialized polyethylene-based polymer having a density range of 0.75 g/cm³ to 1.00 g/cm³ and a melting point range of 80° C. to 120° C.;
(2) cutting the multilayer barrier material to a desired silhouette to provide a blank including a first and a second longitudinal ends;
(3) skiving the first longitudinal end of the blank to a predetermined thickness for a predetermined width;
(4) applying heat to the skived portion of the blank;
(5) folding the skived portion of the blank over onto the blank so that the first longitudinal end of the blank is folded;
(6) hemming both longitudinal ends of the blank together in overlapping relation with the folded first longitudinal end inside the second longitudinal end to form a container body component characterized by an upper end and a lower end;
(7) providing a bottom component;
(8) assembling the bottom component to the lower end of the container body component;
(9) providing a lid component; and
(10) hermetically sealing the lid component to the upper end of the container body component.

FIG. 5 shows one embodiment of the disclosed hermetically-sealed paperboard container. The container 500 includes a body component 501, a lid component 502, and a bottom component 503. The upper end of the body 501 is rolled over so as to form a bead or flange 504, while the bottom end of the body 501 is constructed into a recessed configuration 505. The lid component 502 is hermetically sealed onto the upper end of the body 501 at the processing conditions that provides the adhesion between the sealant layer 502B of the lid component 502 and the sealant layer 501B of the body 501 at the contact point 506. The bottom 503 component is placed and sealed into the recessed end of the body 501 so that there is adhesion between the sealant layer 503B of the bottom component 503 and the sealant layer 501B of the body 501 at the contact point 507, and the sealant completely fills any gap 507 between the bottom component 503 and the body 501.

The disclosed hermetically-sealed paperboard containers are produced from the flat blanks of paperboard having functionalized coating layers, rather than continuous webs of paperboard ply and inner ply of functionalized layers. The flat blanks used in the present disclosure may be shipped and stored flat; therefore, a substantial saving may be achieved due to a reduced storage and shipping costs. Furthermore, the handling efficiency during manufacturing production may be improved significantly because of the compactness of the flat blanks

The disclosed hermetically-sealed containers have excellent barrier performance and may be produced using the standard cup converting machine, whether round or non-round container.

The disclosed multilayer barrier materials may be converted to hermetically-sealed containers with improved barrier performance using the standard cup converting machine and by a careful selection and control of converting conditions, such as sealing time, temperature and pressure.

TABLE 1 shows the temperatures of hot air needed for preheating and heating the sealant layer prior to a formation of the hermetically-sealed container. The multilayer barrier material of FIG. 3, which is one embodiment of the present disclosure, was used to form hermetically-sealed cup using the convention cup forming machine. The multilayer material of FIG. 2, which is typically used for barrier packaging applications, was used as a control for comparing the converting temperatures needed for the disclosed hermetically-sealed container versus the convention container. Additionally, the formed containers were tested for pin holes. A red dye solution was dispensed in the formed container and allowed to flow along the bottom seal. After 5 minutes, the container was rinsed out with water, and the pin holes were recognized as red stains.

TABLE 1

| | Container made of | |
|---|---|---|
| | | Disclosed |
| | Material | Material |
| | of FIG. 2 | of FIG. 3 |
| 1st Preheat Temp. (0° F.) | 950 | 750 |
| 2nd Preheat Temp. (0° F.) | 950 | 750 |
| Heat Temp. of Upper Sidewall of Body | 875 | 750 |
| Component (0° F.) | | |
| Heat Temp. of Lower Sidewall of Body | 875 | 500-650 |
| Component (0° F.) | | |
| Heat Temp. of the Bottom Component (0° F.) | 1000 | 700 |
| Pinholes | Sometimes | No |

The disclosed multilayer barrier structure allows for a lower converting temperature compared to the typical temperatures needed for the standard converting process. TABLE 1 indicates that the converting temperature may be reduced by at least about 200° F. (93° C.) when the disclosed multilayer barrier material was used instead of the typical multilayer material. Additionally, the amounts of pin holes formed during the converting process of the disclosed multilayer barrier structure were reduced, if not completely eliminated, which may be due to the lower converting temperature needed compared to the standard converting temperature. Excessive heating is known to cause pin holes in the multilayer structure during the cup forming process.

### Barrier Performance Testing

The oxygen barrier performance of the disclosed hermetically-sealed barrier containers was determined based on the oxygen transmission rate (OTR) at 23° C. and 0% relative humidity. The container made of the disclosed body component and bottom component was sealed with an aluminum foil lid. Then, the lid was penetrated with inlet and outlet copper pipes and hermetically-sealed with hot melt glue. The inlet was connected to nitrogen supply at a flow rate setting of 10 cc/min. The outlet was connected to the oxygen detector. The readings are taken as the OTR value until the oxygen level reached a stable constant.

The hermetically-sealed barrier containers made of multilayer structure of FIG. 2 could provide the OTR, in one example, of 0.22 cc/100 in²/atm/day. However, this low OTR performance could not be achieved consistently, depending on the converting temperature and subsequently the level of pin holes formed during converting process. On the other hand, the disclosed hermetically-sealed barrier containers produced from multilayer structure of FIG. 3 consistently provided OTR below 0.22 cc/100 in²/atm/day. Additionally, the hermetically-sealed barrier containers with even further enhanced OTR performance may be achieved. The disclosed hermetically-sealed barrier containers having an OTR of less than 0.10 cc/100 in²/atm/day may be obtained for some end use applications. In one embodiment, the converting process and the multilayer barrier material may be optimized to provide the hermetically-sealed barrier containers having an OTR range of 0.01-0.10 cc/100 in²/atm/day. In one embodiment, the disclosed hermetically-sealed barrier container has an OTR range of 0.008-0.056/100 in²/atm/day.

The disclosed hermetically-sealed paperboard containers provide excellent barrier performance without the need for metal foils or metal lids to impart the barrier properties.

The barrier performance of the disclosed container may reach the same excellent level of that for composite cans, while offering benefits of much lighter weight and efficient transportation due to nestability.

The disclosed hermetically-sealed barrier containers are suitable as packaging materials of various goods. Examples of such goods include, but are not limited to, snacks, confectionery, soup, chilled ready meal, and meats.

While the disclosure has been described by reference to various specific embodiments, it should be understood that numerous changes may be made within the spirit and scope of the inventive concepts described. It is intended that the disclosure not be limited to the described embodiments, but will have full scope defined by the language of the following claims.

What is claimed is:

1. A hermetically-sealed paperboard container, comprising:
(A) a body component including an upper end, a lower end, and a skive-and-hem side seal, wherein the body component is formed from a blank of multilayer barrier material comprising:
(a) paperboard having a first side and a second side,
(b) a sealant layer on the first side of the paperboard,
(c) a barrier-containing structure on the second side of the paperboard, the barrier-containing structure including:
(i) a layer of barrier material, and
(ii) a layer comprising a specialized low melting point polyethylene-based polymer positioned over the layer of barrier material, wherein the specialized polyethylene-based polymer is characterized by a density range of 0.75 g/cm³ to 1.00 g/cm³ and a melting point range of 80° C. to 120° C.;
(B) a bottom component sealed to the lower end of the body component; and
(C) a lid component hermetically sealed to the upper end of the body component.

2. The container of claim 1, wherein the layer comprising the specialized low melting point polyethylene-based polymer has a thickness range of 0.75 mils to 2.0 mils.

3. The container of claim 1, wherein the specialized low melting point polyethylene-based polymer includes a very low density polyethylene having a density range of 0.880 g/cm³ to 0.915 g/cm³ and a melting point range of 80° C. to 120° C.

4. The container of claim 1, wherein the specialized low melting point polyethylene-based polymer includes ionic polyethylene copolymer.

5. The container of claim 1, characterized by its converting temperature of at least 93° C. lower than that of a container made of same blank of multilayer material but barrier-containing structure is absence of the specialized low melting point polyethylene-based polymer.

6. The container of claim 1, wherein the sealant layer includes a material selected from the group consisting of polyester, linear low density polyethylene (LLDPE), low density polyethylene (LDPE), high density polyethylene (HDPE), ethylene-vinyl acetate copolymer (EVA), ethylene methyl acrylate (EMA), ionomer polymers, and combinations thereof.

7. The container of claim 1, wherein the barrier material includes a member selected from the group consisting of materials derived from ethylene-vinyl alcohol copolymer (EVOH), polyvinyl alcohol, nylons, polyethylene terephthalate (PET), polyamide, polyvinylidene chloride, cyclic olefin copolymer, metalized polymer film, aluminum foil, materials derived from water-based barrier coatings, materials derived from aluminum oxide (Al₂O₃), silicon oxide (SiOₓ) barrier coatings, and combinations thereof.

8. The container of claim 1, wherein the layer of barrier material has a thickness range of 0.25 mils to 0.75 mils.

9. The container of claim 1, wherein the barrier-containing structure further includes a layer of additional polyethylene-based polymer on a surface of the layer of barrier material opposite to the layer comprising specialized low melting point polyethylene-based polymer.

10. The container of claim 9, wherein the additional polyethylene-based polymer includes a member selected from the group consisting of linear low density polyethylene (LLDPE); low density polyethylene (LDPE); high density polyethylene (HDPE); and combinations thereof.

11. The container of claim 1, wherein the barrier-containing structure has a thickness range of 2.0 mils to 4.0 mils.

12. The container of claim 1, wherein the barrier-containing structure is characterized by a pre-formed structure.

13. The container of claim 1, wherein each layer of the barrier-containing structure is placed on the second side of the paperboard consecutively.

14. The container of claim 1, wherein the multilayer barrier material further comprising a tie layer positioned between the second side of the paperboard and the barrier-containing structure.

15. The container of claim 1, wherein at least one of the bottom component and the lid component comprises:
(a) a substrate having a first side and a second side,
(b) a sealant layer on the first side of the substrate, and
(c) a barrier-containing structure on the second side of the substrate, the barrier-containing structure including:
(i) a layer of barrier material, and
(ii) a layer comprising a specialized low melting point polyethylene-based polymer positioned over the layer of barrier material, wherein the specialized polyethylene-based polymer is characterized by a density range of 0.75 g/cm³ to 1.00 g/cm³ and a melting point range of 80° C. to 120° C.

16. The container of claim 15, wherein the substrate includes one member selected from the group consisting of paper-based material; plastics; foil-based materials; metallized film; and combinations thereof.

17. The container of claim 1, wherein at least one of the bottom component and the lid component is made of same multilayer barrier material as that of the body component.

18. The container of claim 1, wherein at least one of the bottom component and the lid component is derived from material including a member selected from the group consisting of plastics; foil-based materials; metallized film; and combinations thereof.

19. The container of claim 1, characterized by an oxygen transmission rate of less than 10 cc/100 in²/atm/day at a temperature of 23° C. and 0% relative humidity.

20. The container of claim 1, characterized by an oxygen transmission rate of less than 0.22 cc/100 in²/atm/day at a temperature of 23° C. and 0% relative humidity.

21. A method of producing a hermetically-sealed paperboard container, comprising steps of:
(1) producing a multilayer barrier material that comprises:
(a) paperboard having a first side and a second side,
(b) a sealant layer on the first side of the paperboard,
(c) a barrier-containing structure on the second side of the paperboard, the barrier-containing structure including:
(i) a layer of barrier material, and
(ii) a layer comprising a specialized low melting point polyethylene-based polymer positioned over the layer of barrier material, wherein the specialized polyethylene-based polymer is characterized by a density range of 0.75 g/cm³ to 1.00 g/cm³ and a melting point range of 80° C. to 120° C.;
(2) cutting the multilayer barrier material to a desired silhouette to provide a blank including a first and a second longitudinal ends;
(3) skiving the first longitudinal end of the blank to a predetermined thickness for a predetermined width;
(4) applying heat to the skived portion of the blank;
(5) folding the skived portion of the blank over onto the blank so that the first longitudinal end of the blank is folded;
(6) hemming both longitudinal ends of the blank together in overlapping relation with the folded first longitudinal end inside the second longitudinal end to form a container body component characterized by an upper end and a lower end;
(7) providing a bottom component;
(8) assembling the bottom component to the lower end of the container body component;
(9) providing a lid component; and
(10) hermetically sealing the lid component to the upper end of the container body component.
